(19) United States
(12) Patent Application Publication
(10) Pub. No.: US 2003/0068023 A1
(43) Pub. Date: Apr. 10, 2003

(54) E-mail card: sending e-mail via telephone

(76) Inventor: Bruce Singh, Ozone Park, NY (US)

Correspondence Address: Bruce Singh, 114-40 126 St., Ozone Park, NY, 11420, US

(21) Appl. No.: 09/973,460

(22) Filed: Oct. 10, 2001

(51) Int. Cl. H04M 11/00

(52) U.S. Cl. 379/93.24; 379/93.15

(57) ABSTRACT

The E-mail Card is the process of sending e-mail messages via the telephone. The process was made possible by integrating principles of telecommunications, computers, and the Internet. After dialing an access number and entering the PIN number, the customer is prompted by the server to say his or her message which is converted via voice recognition technology to text, inserted in e-mail to be sent. If the message is saved in voice form, it is attached to e-mail as a .wav file. In order to receive messages, an incoming text message is converted into a voice message that is played over the telephone. Possible additions to the present invention are features like a calling card, voice to fax, or e-mail to fax.

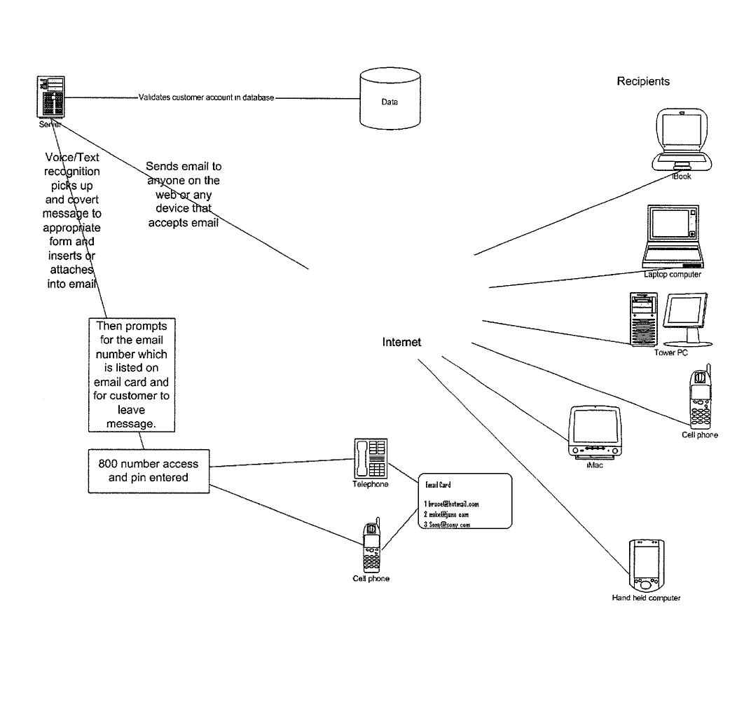

### BACKGROUND OF THE INVENTION

1. Field of Invention

The present invention relates to the field of e-mail communications performed via the telephone. Particularly the present invention relates to sending and receiving e-mail messages via standard telephones and wireless cellular phones. This invention addresses the needs of consumers to be able to access e-mail without being bound to computers or any other device.

### REFERENCES CITED

### U.S. Patent Documents

| | | |
|---|---|---|
| 6,023,700 | February, 2000 | Owens, et al. |
| 6,161,007 | December, 2000 | McCutcheon, et al. |
| 6,249,808 | June, 2001 | Seshadri |

2. Description of Related Art

Communications technology today allows individuals to send messages to one another from virtually any location at any time. Moreover, the individuals can choose from a variety of communication media available to choose one appropriate under certain circumstances. However, depending on where a particular customer is located, it may be inconvenient for him or her to retrieve, and especially send, e-mail messages for instance to the recipient. Using a standard telephone or a wireless cellular phone to receive and send e-mail is one solution to the problem.

The inability to alter the message medium after an e-mail message has been sent unnecessarily burdens the message receivers, and particularly the message sender who wants to compose a new email message to a certain recipient. To date, various solutions have been offered, as to the possibility to retrieve e-mail messages using a telephone. Converting of the e-mail messages into voice and delivering the voice to the user via the telephone connection may be coupled by possibly some other addition of being able to reply to e-mails received via the phone. But it is to be noted that no invention to date allows for actually originating an e-mail message via the telephone to practically any person that a certain user may wish send e-mail.

“Unified messaging” allows for instance to “listen” to e-mail messages that originated as text messages via a standard telephone, and possibly to forward a message from the telecommunications service to the e-mail service. It must be noted however that message receivers are generally required to integrate the Text-To-Speech technology into their own customized telecommunications/computer environments. This could mean higher costs, as well special training for their users. Most importantly, today still there is no method for delivering email messages to standard or wireless telephones, which would also allow for forwarding of new messages via said telecommunications devices to any person.

### BRIEF SUMMARY OF THE INVENTION

The present invention addresses the limitations in the ability of senders to send e-mail via the telephone to a certain person. The customer is able to receive e-mail messages as well as send new ones via a standard telephone. The E-mail Card, similar to calling cards but utilizing data technologies instead of voice, was enabled by integrating features of telecommunications, computers, and the Internet.

After dialing an access number and entering his or her PIN number the customer can choose a slot number representing a certain person email address to which he or she wants to send e-mail to. The customer is prompted to speak and to press the pound button (#) when finished. The voice message is picked up by the server and converted into a text message via voice/text recognition software, inserted in e-mail and sent. If the customer chooses the message to be sent in voice form, the message will be saved as a .wav file, and sent as an e-mail attachment.

In order for the customer to receive messages, the incoming text messages are converted into voice messages via a text/voice converter, and played over the telephone. Possible additions to the present invention are features like the calling card, allowing for calling a person by saying the name of that person or his or her telephone number. Another addition would be the fax retrieval feature allowing the customer to have voice mail or e-mail messages forwarded io a fax machine.

### BRIEF DESCRIPTION OF THE DRAWING

In the Drawing:

The diagram 1/1 is an exemplary diagram of the way the process of sending e-mails via a standard or wireless cellular phone works. Particularly it visually describes the means by which the message server forwards the message converted into text form, as well as the means by which the recipient is able to retrieve the e-mail messages sent.

### DETAILED DESCRIPTION OF THE INVENTION

The present invention is a sophisticated system that facilitates the exchange of e-mail messages via telecommunications devices, such as a standard telephone or wireless cellular phones. It is a process that makes possible for a particular customer to receive and send e-mail without the need of a computer or any other devices besides a standard telephone. It is an inexpensive and convenient way to streamline e-mail communications between senders and receivers who happen to be away of a computer at a given time.

The present invention offers its features to both “senders” and “receivers” of messages. Senders are users who address e-mail or telephone communications to receivers; they use a computer/modem or a telephone to send messages. Receivers are the users to whom the individual e-mail or voice messages are addressed. The receiver can receive an email message that originated as a voice message from the sender, while the sender can send a voice message that will be forwarded in text form to the receiver.

The piece of software that enables the actual process of converting originating voice messages into text messages to be inserted in e-mail is the voice/text recognition software. Through this technology the voice message is converted either into text or saved as a voice file—usually a .wav file, depending on the customer preference, and respectively inserted or attached to e-mail. The actual E-mail Card is the embodiment of the present invention that allows the customer to access or send messages to another person. Despite the similarity to a celling card, the E-mail Card utilizes data technologies instead of voice.

On a certain customer's e-mail card there is available an access number which can be either 800/888 number, or a local or international toll-free service number. This number is accessible via the customer PIN number listed on his or her e-mail card. Additionally there is an e-mail address listed which is supplied to the customer; this address that can be given to anyone the customer wants to receive e-mails messages from. At the same time, the e-mail addresses of the persons the customers wants to send e-mail messages are listed on the card, each of which has a number or letter assignment next to it. These numbers usually-vary from 0 to 99 but the size of the listing depends on the number of e-mails the customer has.

After the customer accesses the server he or she can select 1 to send messages or 2 to hear messages received. In the sending menu the customer selects the format of the message to be sent, whether it will be voice or text. After selecting the number corresponding to the person e-mail address that he or she wants to send e-mail to, the server prompts him/her to say the actual message. The voice message is converted by means of voice recognition software to text and inserted in the email if the customer selected the text format; in case the voice format was selected, the message will be saved as a .wav file and attached to e-mail In order for the customer to hear e-mail messages received via the telephone, he or she presses 2. Incoming text messages are converted into voice messages by means of text/voice conversion software, and played over the telephone.

The diagram on drawings page (1/1) illustrates, in general form, the way the e-mail card functions. After the customer dials the 800 number via a standard telephone or a wireless cellular phone he or she is required to enter his or her PIN number. The customer accesses the server by means of a T-1 card (which has 24 voice channels) within the server shown in the diagram. At this point, the customer account is validated in the database. In case the customer's account is not yet active, he or she should contact a customer service number to have the account activated.

Once the connection is established, the server prompts the customer for the particular e-mail number corresponding to the person's e-mail address that he or she wants to send e-mail to. The listing of the e-mail addresses the customer has available to send e-mail messages is shown in a simplified form in the diagram. The voice message recorded is picked up by the server and then converted by means of voice to text conversion software into a text message. This e-mail message, whether in text form, or having a voice file attachment when the customer has selected the option to send his or her message in voice form, can be send to the Internet or any other device that accepts e-mail; in the diagram the recipients are shown by a laptop computer, a cell phone (the messages are read via the Short Message Service), a hand held computer (palmer PC), or a Tower PC.

Possible additions to the present invention are the calling card and fax retrieval features. The calling card will allow the customer to call anyone domestically or internationally just by saying that particular person's name or telephone number. The fax retrieval feature allows for forwarding voice or e-mail messages to a fax machine. One example would be the ability to receive e-mail messages via a fax machine. The receiver specifying that the preferred communication medium is via fax, can have e-mail messages forwarded to his or her fax machine. Voice messages as well may be forwarded to the fax machine. Message reformatting or conversion is performed in these cases automatically at the telecommunications or e-mail service provider that delivers inbound messages.

What is claimed is:

1. A method for sending e-mail messages via the telephone comprising the steps of:
picking up of a voice message by the message server;
converting said voice message into a text message; and
sending said text message inserted in e-mail.

2. The method of claim 1 further comprising the steps of:
establishing a data channel from said message server; and
transmitting said voice message from said message server via said data channel;

3. The method of claim 1 further comprising the step of:
having the option to choose whether said voice message will be converted into said text message or it will be saved as a voice file.

4. A method of operation of an e-mail card comprising the steps of:
originating a voice message;
converting said voice message into a text message; and
providing said text message to a user in email form.

5. The method of claim 4 further comprising the step of:
determining the option of sending said voice message in text form or as a voice file attachment to e-mail.

6. An e-mail card comprising of:
a message server for processing and sending each message;
a communication interface for sending a voice message in text form; and
a voice to text converter to convert a voice message into a text message when such desired action has been entered.

7. The e-mail card of claim 6 further, comprising:
an options menu from where to choose whether said voice message will be sent as a voice file attachment or will be converted into said text message.
